(19) United States
(12) Patent Application Publication
(10) Pub. No.: US 2026/0012858 A1
(43) Pub. Date: Jan. 8, 2026

(54) NETWORK DEVICE AND METHOD FOR PREDICTION INFORMATION EXCHANGE UNDER DUAL CONNECTIVITY MODE

(71) Applicant: LENOVO (BEIJING) LIMITED, Beijing (CN)

(72) Inventors: Congchi Zhang, Shanghai (CN); Mingzeng Dai, Shanghai (CN); Le Yan, Shanghai (CN); Shuigen Yang, Shanghai (CN)

(21) Appl. No.: 18/992,093

(22) PCT Filed: Jul. 8, 2022
(86) PCT No.: PCT/CN2022/104646

§ 371 Date: Jan. 7, 2025

(51) Int. Cl. H04W 36/00; H04L 41/147; H04L 43/0817

(52) U.S. Cl. CPC H04W 36/0069; H04L 41/147; H04L 43/0817

(57) ABSTRACT

A network device and method for prediction information exchange under dual connectivity mode. The network device serves a UE under a dual connectivity mode. The network device generates a prediction information associated with a UE under the dual connectivity mode, and transmits the prediction information to another network device. The another network device serves the UE under the dual connectivity mode.

### TECHNICAL FIELD

Embodiments of the present application generally relate to wireless communication technology, especially to a network device and a method for prediction information exchange under dual connectivity mode.

### BACKGROUND

In conventional network, a network device can conduct predictions based on input received from neighbour network device(s) according to artificial intelligence model (e.g., machine learning model), or provide prediction results to the neighbour network device(s) upon requests. The prediction operation may be applied to different network environments. However, specific details of exchange prediction information between the network devices under dual connectivity mode have not been discussed yet and there are still some issues that need to be solved.

### SUMMARY

Some embodiments of the present application provide a network device. The network device includes: a processor and a transceiver coupled to the processor. The processor is configured to: generate a prediction information associated with the UE under the dual connectivity mode; and transmit the prediction information to another network device, wherein the another network device serves the UE under the dual connectivity mode.

Some embodiments of the present application provide a network device. The network device includes: a processor and a transceiver coupled to the processor. The processor is configured to: receive a prediction information from another network device, wherein the prediction information is generated by the another network device which serves the UE under the dual connectivity mode.

Some embodiments of the present application provide a method. The method includes: generating, via the network device, a prediction information associated with the UE under the dual connectivity mode; and transmitting the prediction information to another network device, wherein the another network device serves the UE under the dual connectivity mode.

Some embodiments of the present application provide a method. The method includes: receive a prediction information from another network device, wherein the prediction information is generated by the another network device which serves the UE under the dual connectivity mode.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present application.

FIGS. 2A to 2C are schematic diagrams of message transmission in accordance with some embodiments of the present application.

FIG. 3 is a schematic diagram of message transmission in accordance with some embodiments of the present application.

FIG. 4 is a schematic diagram of message transmission in accordance with some embodiments of the present application.

FIG. 5 illustrates a flow chart of a method for wireless communications in accordance with some embodiments of the present application.

FIG. 6 illustrates a block diagram of a network device in accordance with some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. Embodiments of the present application may be provided in a network architecture that adopts various service scenarios, for example but is not limited to, 3GPP 3G, long-term evolution (LTE), LTE-Advanced (LTE-A), 3GPP 4G, 3GPP 5G NR (new radio), etc. It is contemplated that along with the 3GPP and related communication technology development, the terminologies recited in the present application may change, which should not affect the principle of the present application.

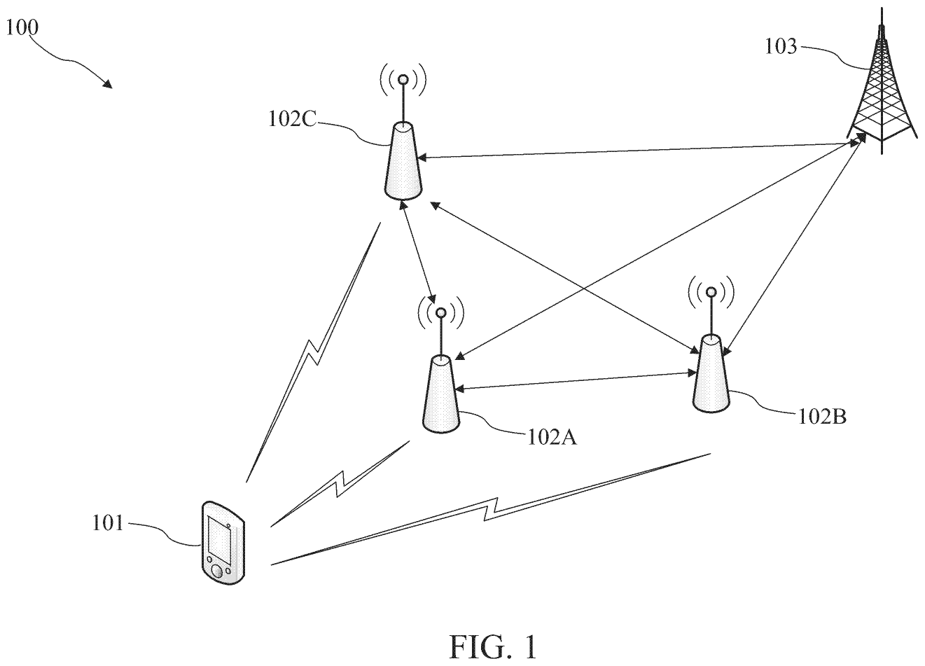

Referring to FIG. 1, a wireless communication system 100 may include a user equipment (UE) 101, network devices 102A, 102B, 102C and a core network (CN) 103. Although a specific number of the UE 101, the network devices 102A, 102B, 102C and the CN 103 are depicted in FIG. 1, it is contemplated that any number of the UEs 101, the network devices 102A, 102B, 102C and the CNs 103 may be included in the wireless communication system 100.

The CN 103 may include a core Access and Mobility management Function (AMF) entity. The BS 102, which may communicate with the CN 103, may operate or work under the control of the AMF entity. The CN 103 may further include a User Plane Function (UPF) entity, which communicatively coupled with the AMF entity.

The network devices 102A, 102B, 102C may be distributed over a geographic region. In certain embodiments of the present application, any of the network devices 102A, 102B, 102C may also be referred to as an access point, an access terminal, a base, a base unit, a macro cell, a Node-B, an evolved Node B (eNB), a gNB, a Home Node-B, a relay node, a central unit (CU) of a base station (BS), a distributed unit (DU) of a BS, a master node (MN) of dual connectivity, a secondary node (SN) of dual connectivity, a CU-control plane (CP) device of a CU of a BS, a CU-user plane (UP) device of a CU of a BS, or described using other terminology used in the art. The network devices 102A, 102B, 102C are generally part of a radio access network that may include one or more controllers communicably coupled to one or more corresponding network device(s). In some embodiments of the present application, the network devices 102A, 102B, 102C may communicate with each other via some interfaces such as Xn/X2 interface between two BSs, F1 interface between a CU and a DU or E1 interface between a CU-CP and a CU-UP.

The UE 101 may include, for example, but is not limited to, computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), Internet of Thing (IoT) devices, or the like.

According to some embodiments of the present application, the UE 101 may include, for example, but is not limited to, a portable wireless communication device, a smart phone, a cellular telephone, a flip phone, a device having a subscriber identity module, a personal computer, a selective call receiver, a wireless sensor, a monitoring device, or any other device that is capable of sending and receiving communication signals on a wireless network.

In some embodiments of the present application, the UE 101 may include, for example, but is not limited to, wearable devices, such as smart watches, fitness bands, optical head-mounted displays, or the like. Moreover, the UE 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE 101 may communicate directly with the network devices 102A, 102B, 102C via uplink (UL) communication signals.

The wireless communication system 100 may be compatible with any type of network that is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, a Long Term Evolution (LTE) network, a 3GPP-based network, a 3GPP 5G network, a satellite communications network, a high altitude platform network, and/or other communications networks.

In some embodiments of the present application, the wireless communication system 100 is compatible with the 5G New Radio (NR) of the 3GPP protocol or the 5G NR-light (or reduced capability NR UEs) of the 3GPP protocol, wherein the network devices 102A, 102B, 102C transmit data using an OFDM modulation scheme on the downlink (DL) and the UE 101 transmits data on the UL using a single-carrier frequency division multiple access (SC-FDMA) or OFDM scheme. More generally, however, the wireless communication system 100 may implement some other open or proprietary communication protocols, for example, WiMAX, among other protocols.

In some embodiments of the present application, the UE 101 and the network devices 102A, 102B, 102C may communicate using other communication protocols, such as the IEEE 802.11 family of wireless communication protocols. Further, in some embodiments of the present application, the UE 101 and the network devices 102A, 102B, 102C may communicate over licensed spectrums, whereas in other embodiments, the UE 101 and the network devices 102A, 102B, 102C may communicate over unlicensed spectrums. The present application is not intended to be limited to the implementation of any particular wireless communication system architecture or protocol. In yet some embodiments of present application, the network devices 102A, 102B, 102C may communicate with the UE 101 using the 3GPP 5G protocols.

In some embodiments, the network devices 102A, 102B, 102C may respectively perform the prediction operation to the UE 101 and generate prediction information associated with the UE 101. The network devices 102A, 102B, 102C may exchange (i.e., transmit or receive) the prediction information from each other.

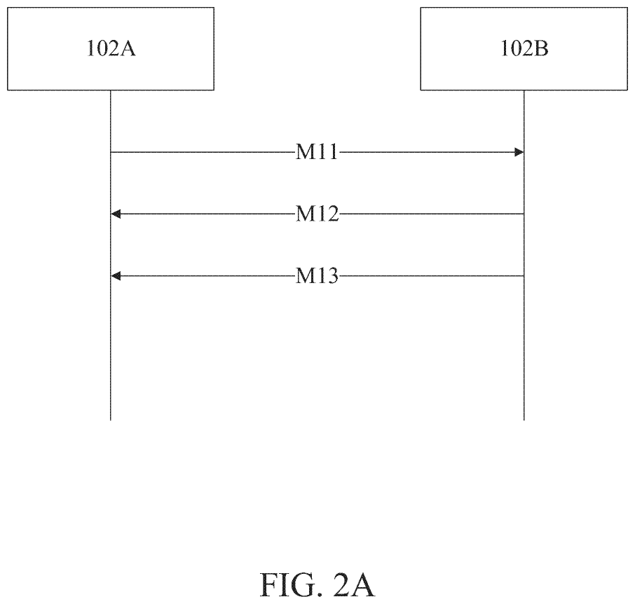

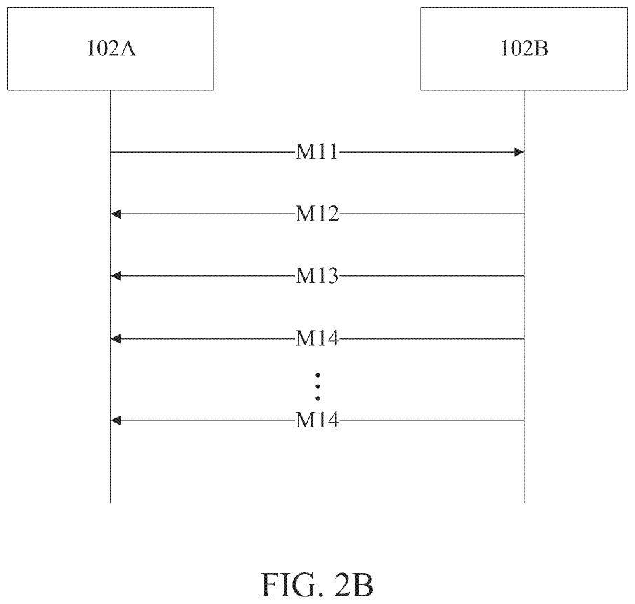

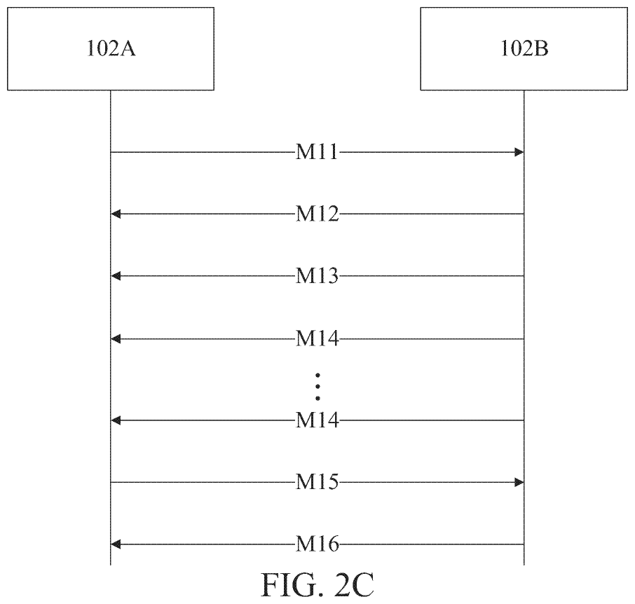

FIG. 2A is a schematic diagram of message transmission in accordance with some embodiments of the present application. In some embodiments, the network device 102A is an MN (or SN) serving the UE 101 under the dual connectivity mode, and the network device 102B is an SN (or MN) serving the UE 101 under the dual connectivity mode.

In particular, the network device 102A transmits a message M11 to the network device 102B. The message M11 may request prediction information from the network device 102B. The network device 102B receives the message M11 and transmits an acknowledgement M12 to the network device 102A. Then, the network device 102B transmits a message M13 including a prediction information to the network device 102A according to the message M11. It should be noted that, in some embodiments, the transmission of acknowledgement M12 may be optional.

In some embodiments, the message M11 may indicate the network device 102B to include at least one of following in the prediction information: (1) a predicted primary cell (PCell) information, a predicted primary secondary cell (PSCell) information, or both the predicted PCell information and the predicted PSCell information; (2) a first predicted cell connection information, a second predicted cell connection information, or both the first predicted cell connection information and the second predicted cell connection information; (3) at least one traffic information on at least one of quality of service (QoS) flow located at the network device 102B; and (4) at least one traffic information on at least one of data radio bearer (DRB) located at the network device 102B. Accordingly, the network device 102B generates the prediction information based on the indication of the message M11.

It should be noted that the prediction information (1) and (2) are UE mobility related. The prediction information (3) and (4) are UE traffic related. The predicted PCell information includes the predicted PCell(s) that the UE 101 is going to connect to. The predicted PSCell information includes the predicted PSCell(s) that the UE 101 is going to connect to. The first predicted cell connection information includes at least one cell that the UE 101 is going to connect to under radio resource control (RRC) connected state. The second predicted cell connection information includes at least one cell that the UE 101 is going to connect to under RRC inactive state or idle state.

In some embodiments, the message M11 may indicate the network device 102B at least one of: (1) a number of predicted cell(s) that the UE 101 is going to connect to (i.e., under active state) or camp on (i.e., under inactive/idle state); and (2) an interval of the prediction information. Accordingly, the network device 102B generates the prediction information based on the indication of the message M11.

For example, when the number of predicted cell is ‘N’, it means that the network device 102B should generate the prediction information having ‘N’ predicted cell(s) that the UE 101 is going to connect to or camp on. For another example, when the interval of the prediction information is timing ‘T1’ to ‘T2’, it means that the network device 102B should generate the prediction information within ‘T1’ to ‘T2’.

In some embodiments, when the message M11 indicates the network device 102B the number ‘M’ of predicted cell that the UE 101 is going to connect to or camp on, the network 102B may generate the prediction information having: (1) the number ‘M’ of predicted cell; or (2) a number ‘m’ of predicted cell while ‘m’ is smaller than ‘M’.

In some embodiments, the prediction information may be generated and provided with a time information. For example, when the prediction information includes an event predicted to happen at timing ‘T’, the time information including the timing ‘T’ should be generated with the prediction information and provided to the network device 102A. For another example, when the prediction information is to predict that the UE 101 stay in a situation for a time ‘t1’ to ‘t2’, the time information including the time ‘t1’ to ‘t2’ should be generated with the prediction information and provided to the network device 102A.

In some embodiments, the prediction information may be generated and provided with a probability. For example, when the prediction information is generated, the network device 102B can evaluate a probability of happening of event recorded in the prediction information and provide the prediction information with the probability to the network device 102A.

FIG. 2B is a schematic diagram of message transmission in accordance with some embodiments of the present application. In some embodiments, the message M11 indicates the network device 102B to transmit the prediction information after the prediction information is updated. Therefore, after receiving the message M11, the network device 102B update the prediction information and transmit a message M14 including the updated prediction information to the network device 102A.

In some cases, the network device 102B periodically updates the prediction information. In some cases, the network device 102B updates the prediction information when the network device 102B determines: (1) the UE 101 switches between cells; (2) a status change of the UE 101; or (3) measures a UE status corresponding information.

Regarding (1) the UE 101 switches between cells, for example, the network device 102B is requested to provide the UE mobility related prediction information (e.g., a list of cells the UE 101 is going to connect to or camp on). Because the UE 101 switching from one cell to another cell may lead to the change of the prediction information, the network device 102B updates the prediction information when determining that the UE 101 switches from one cell to another cell.

Regarding (2) a status change of the UE 101, for example, the prediction information is requested to provide the next two predicted cells of UE mobility, and the network device 102B generates the prediction information of that the UE 101 is going to move to cell ‘A’, and the move to cell ‘B’. When the UE 101 moves to cell ‘A’, the prediction information should be updated since there is only one predicted cell (i.e., cell ‘B’) of UE mobility left and the prediction information is requested to provide the next two predicted cells of UE mobility. Accordingly, when the UE moves to cell ‘A’, the network device 102B updates the prediction information to add additional predicted cell after cell ‘B’.

Regarding (2) a status change of the UE 101, for another example, the network device 102B is requested to provide the predicted information in a future time window from a time stamp ‘X’ to a time stamp ‘Y’. Before the time stamp ‘X’, when the predicted information in the future time window is determined to be changed, the network device 102B updates the prediction information and transmits the prediction information to the network device 102A.

In some embodiments, the message M11 may include a value for the network device 102B to determine an interval between two transmissions of the prediction information. In particular, the message M11 includes an interval value. After receiving the message M11, the network device 102B keeps a time difference between two transmissions of the messages M14 including the prediction information greater than the interval value. In some cases, the interval value may be a timer. When the network device 102B transmits Nₜₕ message M14 including the prediction information, the network device 102B starts the timer. The network device 102B does not transmit the (N+1₎th message M14 including the prediction information until the timer expires. Therefore, too frequent transmissions of the prediction information may be avoided.

FIG. 2C is a schematic diagram of message transmission in accordance with some embodiments of the present application. In some embodiments, the network device 102A may request the network device 102B to stop transmitting the prediction information. In particular, the network device 102A transmits a message M15 to the network device 102B. The message M15 indicates the network device 102B to terminate transmission of the prediction information. After receiving the message M15, the network device 102B stops transmitting the prediction information. The network device 102B transmits an acknowledgement M16 to the network device 102A. It should be noted that, in some embodiments, the transmission of acknowledgement M16 may be optional.

In some embodiments, the network device 102B may stop transmitting the prediction information when the prediction information is out-of-date. In some cases, when the network device 102B determines that a current timing is outside a time window of transmitting the prediction information, the network device 102B stops transmitting the prediction information. For example, the network device 102B is requested to provide the predicted information in a time window from a time stamp ‘X’ to a time stamp ‘Y’. After the time stamp ‘Y’, the network device 102B stops transmitting the prediction information.

In some cases, when a UE status corresponding the prediction information is measured, the network device 102B stops transmitting the prediction information. For example, the prediction information provides that the UE 101 is going to move to cell ‘C’, and then to cell ‘D’. When the network device 102B measures that the UE 101 has moved to cell ‘C’, and then to cell ‘D’, the network device 102B stops transmitting the prediction information.

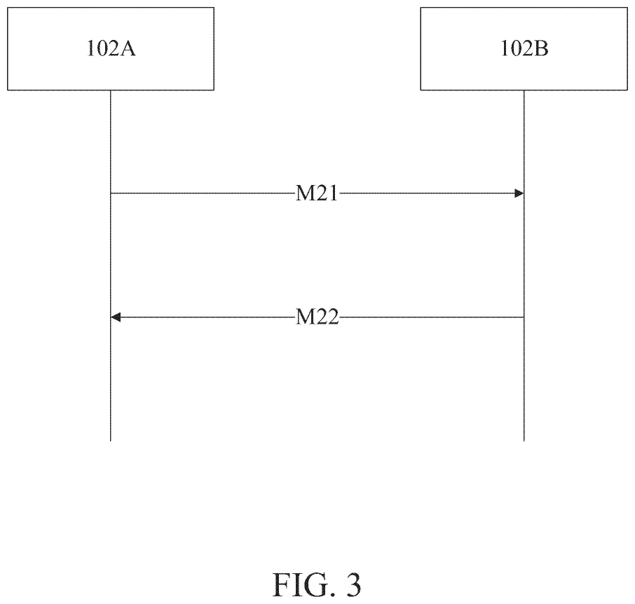

FIG. 3 is a schematic diagram of message transmission in accordance with some embodiments of the present application. In some embodiments, the network device 102A is an MN serving the UE 101 under the dual connectivity mode, and the network device 102B is an SN serving the UE 101 under the dual connectivity mode.

In particular, the network device 102A may initiate an SN adjustment procedure of dual connectivity mode (e.g., an SN addition procedure, an SN change procedure or an SN modification procedure) with the network device 102B. When the network device 102A initiates the SN adjustment procedure with the network device 102B, the network device 102A transmits a message M21 of initiating the SN adjustment procedure of the dual connectivity mode to the network device 102B. In these embodiments, the message M21 may include the prediction information associated with the UE 101. After receiving the message M21, the network device 102B may transmit an acknowledgement M22 to the network device 102A. It should be noted that, in some embodiments, the transmission of acknowledgement M22 may be optional.

For example, when the network device 102A initiates an SN addition/change procedure of dual connectivity mode with the network device 102B, the network device 102A transmits the message M21, which is an SN addition request message (e.g., SN ADDITION REQUEST specified in the 3GPP specification), to the network device 102B. The prediction information is included in the SN addition request message.

For another example, when the network device 102A initiates an SN modification procedure of dual connectivity mode with the network device 102B, the network device 102A transmits the message M21, which is an SN modification request message (e.g., SN MODIFICATION REQUEST specified in the 3GPP specification), to the network device 102B. The prediction information is included in the SN modification request message.

In some embodiments, the prediction information of the message M21 may include at least one of following: (1) a predicted PCell information, a predicted PSCell information, or both the predicted PCell information and the predicted PSCell information; (2) a first predicted cell connection information, a second predicted cell connection information, or both the first predicted cell connection information and the second predicted cell connection information; (3) at least one traffic information on at least one of QoS flow supported by the network device 102B.

It should be noted that the prediction information (1) and (2) are UE mobility related. The prediction information (3) is UE traffic related. The predicted PCell information includes the predicted PCell(s) that the UE 101 is going to connect to. The predicted PSCell information includes the predicted PSCell(s) that the UE 101 is going to connect to. The first predicted cell connection information includes at least one cell that the UE 101 is going to connect to under RRC connected state. The second predicted cell connection information includes at least one cell that the UE 101 is going to connect to under RRC inactive state or idle state. The at least one traffic information is related to the at least one of QoS flow that the network device 102A requests the network device 102B to support. The at least on of QoS flow includes QoS flow using secondary cell group (SCG) bearer resources terminated at the network device 102A or 102B.

In some embodiments, the prediction information may be generated and provided with a probability. For example, when the prediction information is generated, the network device 102B can evaluate a probability of happening of event recorded in the prediction information and provide the prediction information with the probability to the network device 102A.

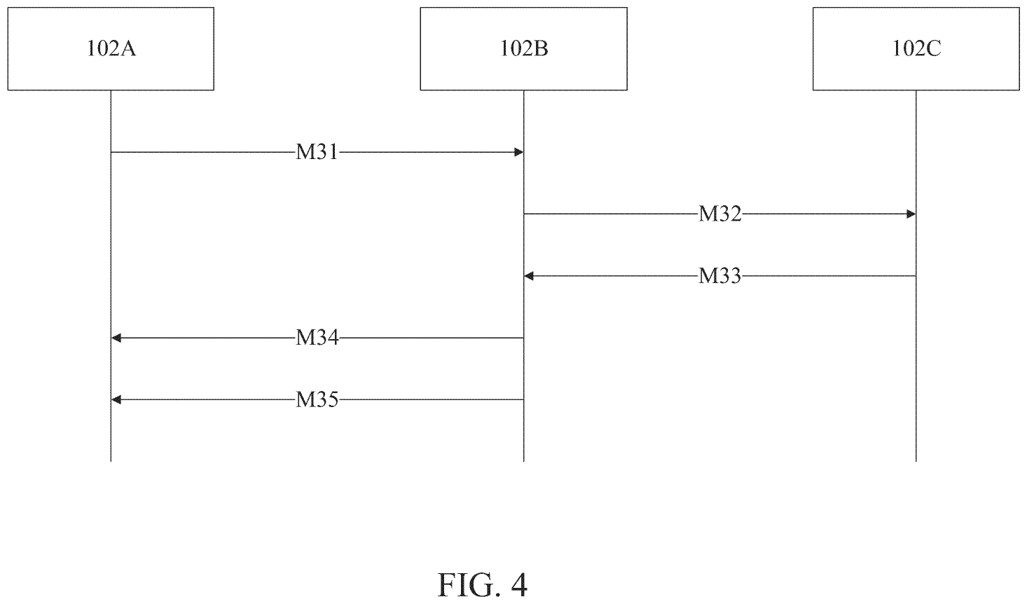

FIG. 4A is a schematic diagram of message transmission in accordance with some embodiments of the present application. In some embodiments, the network device 102A is a source SN serving the UE 101 under the dual connectivity mode, the network device 102B is an MN serving the UE 101 under the dual connectivity mode, and the network device 102C is a target SN serving the UE 101 under the dual connectivity mode.

In particular, the network device 102A may initiate an SN adjustment procedure of dual connectivity mode (e.g., an SN change procedure) with the network device 102B. When the network device 102A initiates the SN adjustment procedure with the network device 102B, the network device 102A transmits a message M31 of initiating the SN adjustment procedure of the dual connectivity mode to the network device 102B. In these embodiments, the message M31 may include the prediction information associated with the UE 101. After receiving the message M31, the network device 102B may update the prediction information and transmit a message M32 including the updated prediction information to the network device 102C. After receiving the message M32, the network device 102C may transmit an acknowledgement M33 to the network device 102B. After receiving the acknowledgement M33, the network device 102B may transmit a message M34 of confirming SN change to the network device 102A. It should be noted that, in some embodiments, the transmissions of acknowledgement M33 and the message M34 may be optional.

For example, when the network device 102A initiates an SN change procedure of dual connectivity mode with the network device 102B, the network device 102A transmits the message M31, which is an SN change required message (e.g., SN CHANGE REQUIRED specified in the 3GPP specification), to the network device 102B. The prediction information is included in the SN change required message.

In some embodiments, the prediction information of the message M31 may include at least one of following: (1) a predicted PCell information, a predicted PSCell information, or both the predicted PCell information and the predicted PSCell information; (2) a first predicted cell connection information, a second predicted cell connection information, or both the first predicted cell connection information and the second predicted cell connection information; (3) at least one traffic information on at least one of QoS flow supported by the network device 102A.

It should be noted that the prediction information (1) and (2) are UE mobility related. The prediction information (3) is UE traffic related. The predicted PCell information includes the predicted PCell(s) that the UE 101 is going to connect to. The predicted PSCell information includes the predicted PSCell(s) that the UE 101 is going to connect to. The first predicted cell connection information includes at least one cell that the UE 101 is going to connect to under RRC connected state. The second predicted cell connection information includes at least one cell that the UE 101 is going to connect to under RRC inactive state or idle state. The at least one traffic information is related to the at least one of QoS flow that the network device 102A currently supports. The at least on of QoS flow includes QoS flow using SCG bearer resources terminated at the network device 102A or 102B.

In some embodiments, the prediction information may be generated and provided with a probability. For example, when the prediction information is generated, the network device 102B can evaluate a probability of happening of event recorded in the prediction information and provide the prediction information with the probability to the network device 102A.

In addition, when the network device 102B receives the SN change required message, the network device 102B updates the prediction information of the SN change required message. Then, the network device 102B transmits the message M32, which is an SN addition request message (e.g., SN ADDITOIN REQUEST specified in the 3GPP specification), to the network device 102C. The updated prediction information is included in the message M32.

In some cases, the network device 102B relays the prediction information from the network device 102A to the network device 102C. In some cases, the network device 102B modifies the prediction information received from the network device 102A by the prediction information generated by the network device 102B itself.

In some implementations of modifying the prediction information received from the network device 102A, when the network device 102B determines that (at least part of) the prediction information received from the network device 102A is different from (at least part of) the prediction information generated by the network device 102B itself, the network device 102B replaces (at least part of) the prediction information received from the network device 102A by the (at least part of) the prediction generated by the network device 102B.

For example, the network device 102A provides both prediction information of UE mobility and prediction information of UE traffic. When the network device 102B determines that the prediction information of UE mobility received from the network device 102A is different from prediction information of UE mobility generated by the network device 102B, the network device 102B transmits: (1) the prediction information of UE mobility generated by the network device 102B; and (2) the prediction information of UE traffic received from the network device 102A to the network device 102C.

In some implementations of modifying the prediction information received from the network device 102A, when the network device 102B generates the prediction information which is not included in the prediction information received from the network device 102A, the network device 102B transmits both the prediction information generated by the network device 102B and the prediction information received from the network device 102A to the network device 102C.

For example, the network device 102A provides only the prediction information of UE traffic. When the network device 102B generates the prediction information of UE mobility, the network device 102B transmits both the prediction information of UE traffic received from the network device 102A and the prediction information UE mobility generated by the network device 102B to the network device 102C.

In some embodiments, after the SN adjustment procedure, the network device 102B may collect (or measure) an actual UE status M35, which corresponds to the prediction information generated by the network device 102A, and then transmit the actual UE status M35 to the network device 102A. Therefore, the network device 102A may determine whether its prediction information is correct and may improve A.I. model of generating the prediction information accordingly.

In some cases, the message M31 may include an indicator to indicate the network device 102B to transmit the actual UE status M35 back to the network device 102A after the SN adjustment procedure is done. In some cases, the message M31 may include an identification corresponding to the prediction information generated by the network device 102A. Accordingly, the network device 102B may refer to the identification to transmit the actual UE status M35 corresponding to the prediction information back to the network device 102A.

For example, the message M31 includes a prediction information ‘A’ and an identification ‘#1’ corresponding to the prediction information ‘#A’. After the SN adjustment procedure is done, the network device 102B collect an actual UE status ‘#a’ corresponding to the prediction information ‘#A’ and transmits the actual UE status ‘#a’ with the identification ‘#1’ to the network device 102C. Therefore, after receiving the actual UE status ‘#a’ with the identification ‘#1’, the network device 102C can pair the actual UE status ‘#a’ with the prediction information ‘A’.

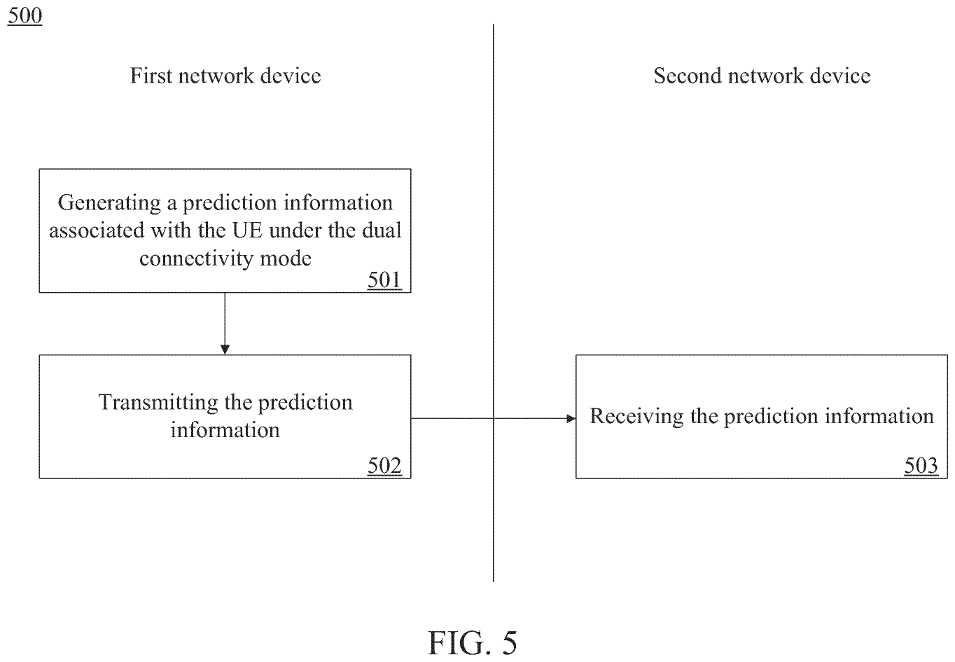

FIG. 5 illustrates a flow chart of a method for wireless communications in accordance with some embodiments of the present application. Referring to FIG. 5, method 500 is performed by a first network device and a second network device in some embodiments of the present application. The first network device and the second network device serve a UE under a dual connectivity mode.

In some embodiments, operation S501 is executed to generate, via the first network device, a prediction information associated with the UE under the dual connectivity mode. Operation S502 is executed to transmit, via the first network device, the prediction information to the second network device. Operation S803 is execute to receive, via the second network device, the prediction information from the first network device.

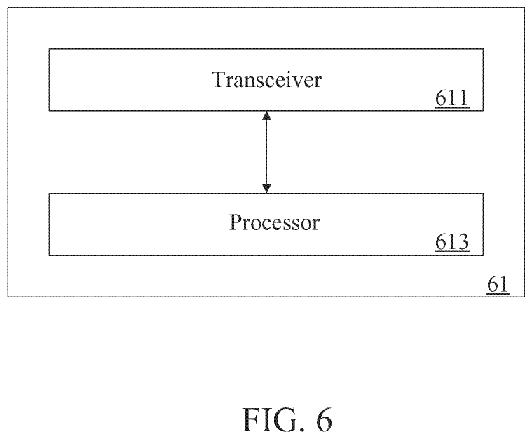

FIG. 6 illustrates an example block diagram of a network device 61 according to an embodiment of the present disclosure.

As shown in FIG. 6, the network device 61 may include at least one non-transitory computer-readable medium (not illustrated in FIG. 6), a transceiver 611 and a processor 613 electrically coupled to the non-transitory computer-readable medium (not illustrated in FIG. 6) and the transceiver 611. The network device 61 may be a BS, an MN of dual connectivity, an SN in of dual connectivity.

Although in this figure, elements such as processor 613 and transceiver 611 are described in the singular, the plural is contemplated unless limitation to the singular is explicitly stated. In some embodiments of the present disclosure, the transceiver 611 may be separated into to circuitry, such as a receiving circuitry and a transmitting circuitry. In certain embodiments of the present disclosure, the network device 61 may further include an input device, a memory, and/or other components.

In some embodiments of the present disclosure, the non-transitory computer-readable medium may have stored thereon computer-executable instructions to cause a processor to implement the method with respect to the user equipment as described above. For example, the computer-executable instructions, when executed, cause the processor 613 interacting with the transceiver 611, so as to perform the operations with respect to the network device depicted in the figures.

Those having ordinary skill in the art would understand that the operations of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes”, “including”, or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a”, “an”, or the like does not, without more constraints, preclude the existence of additional identical elements in the process, method, article, or apparatus that includes the element. Also, the term “another” is defined as at least a second or more. The term “having” and the like, as used herein, are defined as “including”.

In this document, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A network device serving a user equipment (UE) under a dual connectivity mode, the network device comprising:
at least one memory; and
at least one processor coupled with the at least one memory and configured to cause the network device to:
generate a prediction information associated with the UE under the dual connectivity mode; and
transmit the prediction information to another network device, wherein the another network device serves the UE under the dual connectivity mode.

2. The network device of claim 1, wherein the at least one processor is configured to cause the network device to:
receive a message of requesting the prediction information from the another network device.

3. The network device of claim 2, wherein the message indicates the network device to transmit the prediction information after the prediction information is updated, and the at least one processor is configured to cause the network device to:
update the prediction information associated with the UE; and
transmit the prediction information to the another network device.

4. The network device of claim 3, wherein the prediction information is periodically updated or is updated when the at least one processor is configured to cause the network device to:
measure a UE status corresponding to the prediction information; or
determine the UE switches between cells; or
determine a status change of the UE.

5. The network device of claim 4, wherein the at least one processor is configured to cause the network device to stop transmitting the prediction information when:
receiving another message from the another network device, wherein the another message indicates the network device of terminating transmission of the prediction information;
determining a current timing is outside a time window of transmitting the prediction information; or
a UE status corresponding the prediction information is measured.

6. The network device of claim 3, wherein the message includes an interval value, and the at least one processor is configured to cause the network device to:
keep a time difference between two transmissions of the prediction information greater than the interval value.

7. The network device of claim 2, wherein the message indicates the network device to include at least one of following in the prediction information:
a predicted PCell information, a predicted PSCell information, or both the predicted PCell information and the predicted PSCell information;
a first predicted cell connection information, a second predicted cell connection information, or both the first predicted cell connection information and the second predicted cell connection information, wherein the first predicted cell connection information includes at least one cell that the UE connects with under RRC connected state, and the second predicted cell connection information includes at least one cell that the UE connects with under RRC inactive state or idle state;
at least one traffic information on at least one of QoS flow located at the network device; and
at least one traffic information on at least one of DRB located at the network device.

8. The network device of claim 7, wherein the message indicates the network device at least one of:
a number of predicted cell that the UE is going to connect to or camp on; and
an interval of the prediction information.

9. The network device of claim 1, wherein the another network is a target network device, and the at least one processor is configured to cause the network device to:
receive a message of initiating a secondary node adjustment procedure of the dual connectivity mode from a source network device, wherein the message includes another prediction information associated with the UE.

10. The network device of claim 9, wherein a secondary node adjustment procedure includes a secondary node addition procedure or a secondary node change procedure, the message includes a secondary node change required message, and the another prediction information includes at least one of:
a predicted PCell information, a predicted PSCell information, or both the predicted PCell information and the predicted PSCell information;
a first predicted cell connection information, a second predicted cell connection information, or both the first predicted cell connection information and the second predicted cell connection information, wherein the first predicted cell connection information includes at least one cell that the UE connects with under RRC connected state, and the second predicted cell connection information includes at least one cell that the UE connects with under RRC inactive state or idle state; and
at least one traffic information on at least one of QoS flow supported by the source network device.

11. The network device of claim 9, wherein the at least one processor is configured to cause the network device to:
update the prediction information by the another prediction information; and
transmit a secondary node addition request to the target network device, wherein the prediction information is included in the secondary node addition request.

12. The network device of claim 11, wherein the at least one processor is configured to cause the network device to:
collect a UE status corresponding to the prediction information; and
transmit the UE status to the source network device.

13. The network device of claim 12, wherein the at least one processor is configured to cause the network device to:
receive an indicator from the source network device, wherein the indicator indicates the network device to transmit the UE status.

14. A network device serving a user equipment (UE) under a dual connectivity mode, the network device comprising:
at least one memory; and
at least one processor coupled with the at least one memory and configured to cause the network device to:
receive a prediction information from another network device, wherein the prediction information is generated by the another network device which serves the UE under the dual connectivity mode.

15. A method of a network device serving a user equipment (UE) under a dual connectivity mode, the method comprising:
generating, via the network device, a prediction information associated with the UE under the dual connectivity mode; and
transmitting the prediction information to another network device, wherein the another network device serves the UE under the dual connectivity mode.

16. A processor for wireless communication, comprising:
at least one controller coupled with at least one memory and configured to cause the processor to:
generate a prediction information associated with a user equipment (UE) under a dual connectivity mode; and
transmit the prediction information to another network device, wherein the another network device serves the UE under the dual connectivity mode.

17. The processor of claim 16, wherein the at least one controller is configured to cause the processor to:
receive a message of requesting the prediction information from the another network device.

18. The processor of claim 17, wherein the message indicates the network device to transmit the prediction information after the prediction information is updated, and the at least one controller is configured to cause the processor to:
update the prediction information associated with the UE; and
transmit the prediction information to the another network device.

19. The processor of claim 18, wherein the prediction information is periodically updated or is updated when the at least one controller is configured to cause the processor to:
measure a UE status corresponding to the prediction information; or
determine the UE switches between cells; or
determine a status change of the UE.

20. The processor of claim 19, wherein the at least one controller is configured to cause the processor to stop transmitting the prediction information when:
receiving another message from the another network device, wherein the another message indicates the network device of terminating transmission of the prediction information;
determining a current timing is outside a time window of transmitting the prediction information; or
a UE status corresponding the prediction information is measured.
